(19) United States
(12) Patent Application Publication
(10) Pub. No.: US 2026/0241523 A1
(43) Pub. Date: Aug. 20, 2026

(54) NAIL DRIVING MACHINE

(71) Applicant: Max Co., Ltd., Tokyo (JP)

(72) Inventors: Kousuke Moriwaki, Tokyo (JP); Takuma Yoshida, Tokyo (JP)

(21) Appl. No.: 19/542,246

(22) Filed: Feb. 17, 2026

(30) Foreign Application Priority Data
Feb. 17, 2025 (JP) 2025-023145

(51) Int. Cl. B25C 1/00; B25C 1/04

(52) U.S. Cl. CPC B25C 1/003; B25C 1/008; B25C 1/047

(57) ABSTRACT

A nail driving machine includes: a magazine configured to accommodate connected nails in which a plurality of nails are connected; and a nose portion having an injection passage of the nails. A feed path configured to guide the connected nails from the magazine to the injection passage is provided. The magazine includes a magazine main body capable of accommodating the connected nails, and a magazine cap portion attached to the magazine main body to be openable and closable. At least a part of the feed path is formed by a nose-side guide surface of the nose portion and a magazine cap-side guide surface of the magazine cap portion.

### CROSS-REFERENCE TO RELATED APPLICATIONS

This application is based on and claims priority under 35 USC §119 from Japanese Patent Application No. 2025-023145 filed on February 17, 2025, the contents of which are incorporated herein by reference.

### TECHNICAL FIELD

The present disclosure relates to a nail driving machine that uses connected nails.

### BACKGROUND

This type of nail driving machine is configured such that connected nails accommodated in a magazine are sequentially fed to an injection passage and driven. The injection passage is formed in a nose portion at a tip end of the tool, and a feed path, which serves as a passage for the connected nails, is formed between the injection passage and the magazine. It is common that the feed path and the injection passage are configured to be openable and closable by a rotatable door. By opening this door, maintenance work and clearing of nail jams are facilitated.

In such a conventional structure, the feed path and the injection passage were formed by the nose portion and the door (refer to JPH08-164502A and JP2008-168361A).

In high-power nail driving machines, it is desirable that the nose portion and the door be formed of metal such as iron in order to ensure durability when nails vibrate. However, when a door made of iron is used, there are problems in that the weight increases, resulting in poorer handling of the machine and degraded balance during use.

Accordingly, the present disclosure has as its object to provide a nail driving machine that can achieve weight reduction even when a door made of metal is used.

### SUMMARY

A nail driving machine includes: a magazine configured to accommodate connected nails in which a plurality of nails are connected; and a nose portion having an injection passage of the nails. A feed path configured to guide the connected nails from the magazine to the injection passage is provided. The magazine includes a magazine main body capable of accommodating the connected nails, and a magazine cap portion attached to the magazine main body to be openable and closable. At least a part of the feed path is formed by a nose-side guide surface of the nose portion and a magazine cap-side guide surface of the magazine cap portion.

### BRIEF DESCRIPTION OF DRAWINGS

FIG. 1 is a side view of a nail driving machine;

FIG. 2 is a side view of the nail driving machine with a magazine and a door open;

FIG. 3 is a perspective view of the nail driving machine;

FIG. 4 is a partially enlarged perspective view of the vicinity of the tip end of a magazine cap portion as viewed from the back side;

FIG. 5A is a plan view of a metal member, FIG. 5B is a side view of the metal member, and FIG. 5C is a perspective view of the metal member;

FIG. 6A is a partially enlarged view of an A-A cross section in FIG. 1, and FIG. 6B is a partially enlarged view of a longitudinal cross section in the vicinity of a nose portion;

FIG. 7A is a view illustrating a state where a feed claw is retracted, and FIG. 7B is a view illustrating a state where the feed claw is advanced; and

FIG. 8 is a sectional view illustrating a movable member according to a modified example.

### DESCRIPTION OF EMBODIMENTS

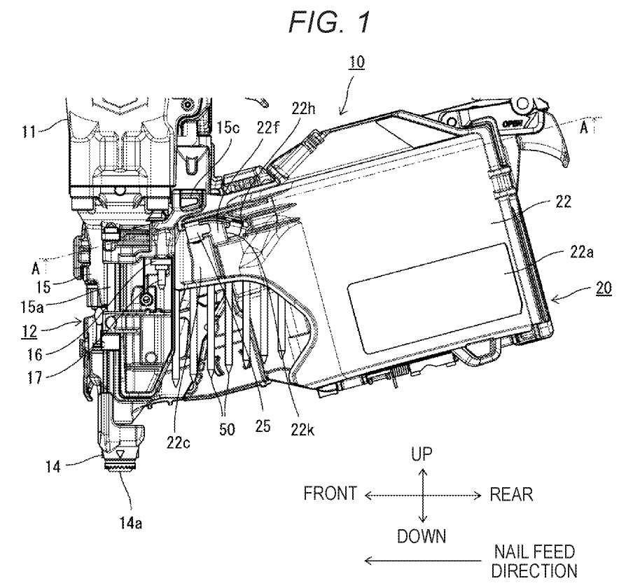

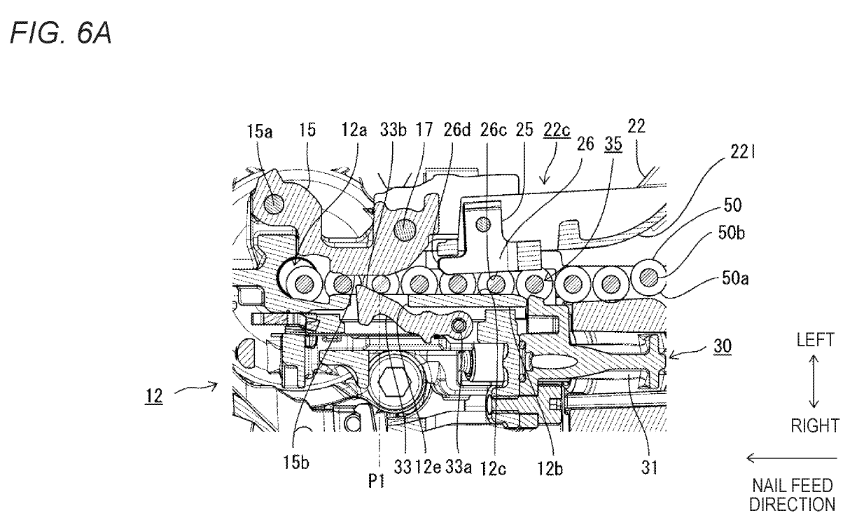

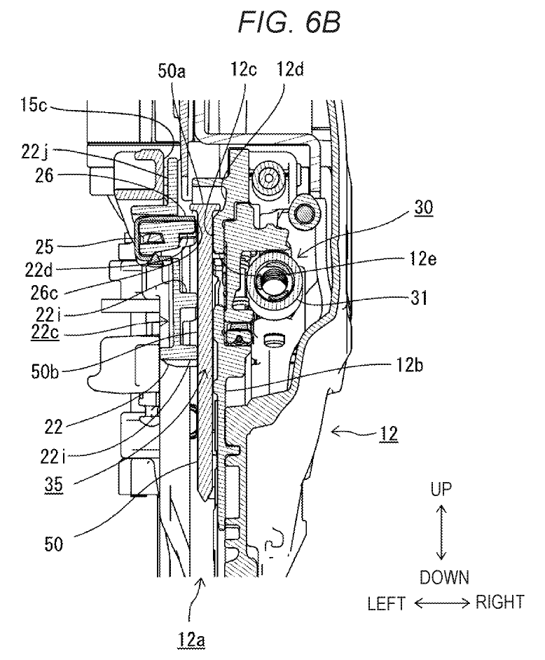

A nail driving machine 10 according to an embodiment of the present invention will be described with reference to the drawings. In the following description, the injection direction of a nail 50 is referred to as “downward” and the direction opposite to the downward direction is referred to as “upward” as illustrated in FIG. 1. In addition, the direction orthogonal to the up-down direction, that is, the direction from a magazine 20 toward a nose portion 12 (nail feed direction), will be referred to as “front”, and the direction opposite to the front direction will be referred to as “rear”. As illustrated in FIGS. 6A, 6B, a direction orthogonal to the up-down direction and the front-rear direction, which is the left direction as seen from an operator holding the nail driving machine 10 (the direction in which a door member 15 and a magazine cap portion 22 open), will be referred to as “left”, and the direction opposite to the left direction will be referred to as “right”.

The nail driving machine 10 according to the present embodiment injects the nail 50 from an injection port 14a formed at the tip end of the machine. The structure of the nail driving machine 10 is well known and therefore will not be described in detail, but the nail driving machine 10 operates using, for example, compressed air, gas, or electricity as a power source. The nail driving machine 10 includes a trigger operable by an operator, and when this trigger is operated, an internal drive mechanism (such as a piston-cylinder mechanism or a spring mechanism) is activated to drive the nail 50.

The above-mentioned drive mechanism is incorporated in a body housing 11. As illustrated in FIG. 1, a nose portion 12 is integrally provided below the body housing 11. An injection passage 12a for the nail 50 is formed inside the nose portion 12. The injection port 14a, which will be described later, is provided below the injection passage 12a. When the drive mechanism is activated, the nail 50 waiting in the injection passage 12a is driven. More specifically, inside the body housing 11, a driver for driving out the nail 50 is slidably guided toward the nose portion 12. When the drive mechanism is activated, the driver is impulsively slid toward the nose portion 12, and the tip end of the driver drives the nail 50 waiting in the injection passage 12a of the nose portion 12.

At least a part of the injection passage 12a is formed by the nose portion 12. The injection passage 12a may be formed by the nose portion 12 alone, or may be formed by combining the nose portion 12 with another member (for example, the door member 15 described later).

A contact member 14 is slidably provided at the tip end of the nose portion 12 according to the present embodiment. The contact member 14 is connected to a contact arm that is provided to be able to reciprocate up and down relative to the body housing 11, and moves integrally with the contact arm. In the natural state before driving, the contact member 14 is biased to protrude in the tip end direction, and in this state, the nail 50 cannot be driven. On the other hand, when the tip end of the contact member 14 is pressed against a workpiece, the contact arm moves together with the contact member 14, a safety mechanism is released, and a fastener can be driven.

The inside of the contact member 14 communicates with the injection passage 12a. Furthermore, at the tip end of the contact member 14, the injection port 14a, which is an outlet through which the nail 50 is driven, is formed. Therefore, the nail 50 driven by the drive mechanism passes through the injection passage 12a and is injected from the injection port 14a.

At the rear of the nose portion 12, the magazine 20 that accommodates connected nails in which the plurality of nails 50 are connected is connected. The connected nails accommodated in the magazine 20 are pulled out toward the nose portion 12 and set in a feed path 35. The feed path 35 is a path that guides the connected nails from the magazine 20 toward the injection passage 12a. In the feed path 35, the posture of the nail 50 is substantially supported, and tilting or shaking of the nail 50 is suppressed. Specifically, the feed path 35 satisfies all of the following (1) to (3). (1) A body portion 50b of the nail 50 is guided, and tilting of the nail 50 is suppressed. (2) The body portion 50b of the nail 50 is guided and the movement of the nail 50 in the left-right direction is restricted. (3) The body portion 50b of the nail 50 is guided with a width equal to or smaller than the diameter of a head portion 50a of the nail 50, thereby suppressing falling of the nail 50 from the feed path 35. The connected nails set in the feed path 35 are automatically supplied to the injection passage 12a of the nose portion 12 by a feed mechanism 30, which will be described later.

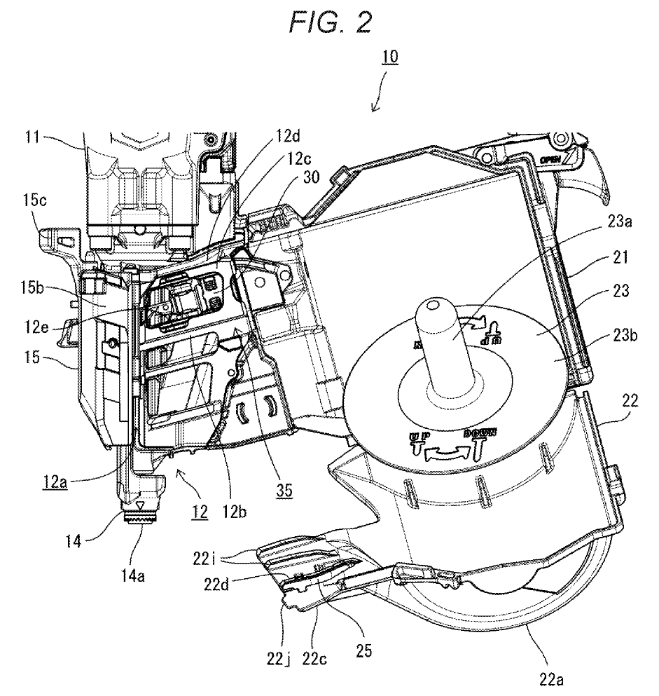

The magazine 20 is formed in a cylindrical shape to be capable of loading the connected nails wound in a coil shape. As illustrated in FIG. 2, the magazine 20 includes a magazine main body 21, a magazine cap portion 22, and a support member 23.

The magazine main body 21 is disposed behind the nose portion 12 and is configured to be able to accommodate the connected nails. The magazine main body 21 may be fixed immovably relative to the nose portion 12, or may be movable relative to the nose portion 12. When the magazine main body 21 is made immovable relative to the nose portion 12, the magazine main body 21 may be indirectly fixed to the nose portion 12 via a separate member. Furthermore, the magazine main body 21 may be movable relative to the nose portion 12 by fixing the magazine main body 21 to a piston-cylinder mechanism 31 that is movable relative to the nose portion 12. The magazine main body 21 is formed in a semi-cylindrical shape, and forms a cylindrical accommodating space in combination with the magazine cap portion 22.

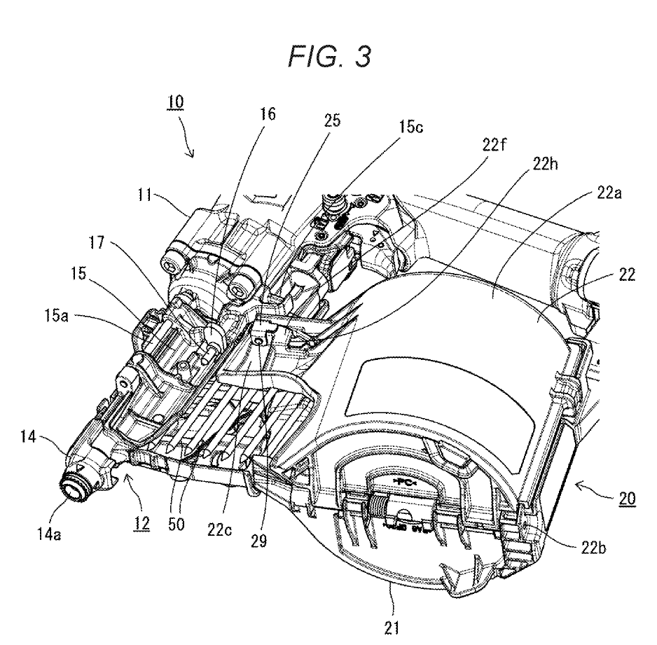

The magazine cap portion 22 is attached to the magazine main body 21 to be openable and closable. As illustrated in FIG. 3, a magazine rotation shaft 22b extending substantially in the front-rear direction may be provided in the vicinity of the lower end of the magazine cap portion 22. The magazine cap portion 22 is attached to the magazine main body 21 to be rotatable via the magazine rotation shaft 22b. As illustrated in FIG. 2, the magazine cap portion 22 can be opened by rotating approximately 180 degrees downward. When the magazine cap portion 22 is opened, the inside of the magazine 20 is exposed, and it becomes possible to load the connected nails.

The magazine cap portion 22 includes a semi-cylindrical half-cylinder portion 22a and a guide forming portion 22c that protrudes forward from the half-cylinder portion 22a. The half-cylinder portion 22a is a part that forms a cylindrical accommodating space in combination with the magazine main body 21. The guide forming portion 22c is a part that forms a part of the feed path 35. The guide forming portion 22c will be described in detail later.

The support member 23 is a member for attaching the connected nails, and is disposed in the accommodating space for the connected nails formed by the magazine main body 21 and the magazine cap portion 22. The support member 23 is configured by erecting a post portion 23a at the center portion of a circular bottom plate portion 23b on which the connected nails are placed. The height of this support member 23 can be adjusted by being rotated. As a result, the position for supporting the nail 50 from below can be changed in accordance with the overall length of the nail 50 loaded into the magazine 20.

The magazine main body 21 and the support member 23 are made of synthetic resin. The magazine cap portion 22 is made of synthetic resin, except for a metal member 25, which will be described later. That is, the main part of the magazine 20 is made of synthetic resin, making the magazine 20 lightweight. Further, by being formed of transparent synthetic resin, the magazine 20 is formed such that the contents can be visually checked.

Next, the feed path 35 of the nail 50 will be described.

As illustrated in FIG. 2, the nose portion 12 includes a guide plate portion 12b extending rearward from the injection passage 12a. The guide plate portion 12b has a nose-side guide surface 12c that forms either the left or right surface of the feed path 35 (the right surface in the present embodiment). The nose-side guide surface 12c is a surface that supports the body portion 50b of the nail 50 disposed in the feed path 35. The nose-side guide surface 12c supports the nail 50 such that the nail 50 does not tilt to the right.

A guide groove 12d for guiding the head portion 50a of the nail 50 is formed in the upper portion of the nose-side guide surface 12c. The guide groove 12d extends along the feed path 35. As illustrated in FIG. 6B, the guide groove 12d holds the head portion 50a of the nail 50 such that the nail 50 does not fall. With this configuration, the guide groove 12d restricts the movement of the nail 50 in the up-down direction and also guides the movement in the nail feed direction.

The above-described nose-side guide surface 12c is desirably formed with a sufficient length in the up-down direction to be able to support the nail 50 up to the vicinity of the tip thereof. Note that, a hole 12e is formed in the nose-side guide surface 12c. By forming this hole 12e, the area of the nose-side guide surface 12c can be ensured while reducing the weight of the machine. Further, the feed mechanism 30, which will be described later, is disposed at the back (right side) of this hole 12e. A feed claw 32 and a check claw 33, which are parts of the feed mechanism 30, are able to protrude into and retract from the feed path 35 through the hole 12e of the nose-side guide surface 12c.

As illustrated in FIG. 1, the door member 15 is provided on the left side of the nose portion 12. The door member 15 according to the present embodiment is made of metal. The door member 15 is attached to the nose portion 12 to be openable and closable. By opening this door member 15, the injection passage 12a and the feed path 35 can be opened. The door member 15 rotates about a shaft 15a provided in the vicinity of the front end. The shaft 15a extends in the up-down direction, and the door member 15 is rotatable in the front-rear direction with a leftward opening.

The door member 15 includes an operating portion 16. The operating portion 16 is used to unlock the door member 15 and is provided to be operable by the operator. The operating portion 16 according to the present embodiment is attached to the door member 15 to be movable up and down, and is biased upward by biasing means (such as a spring) which is not illustrated. When an operator presses down the operating portion 16 against the biasing force of the biasing means, a pin 17 fixed to the operating portion 16 moves downward. The upper end of this pin 17 can be engaged with an engagement hole provided on the nose portion 12 side. As illustrated in FIG. 1, in a state where the door member 15 is closed, the pin 17 is engaged with the engagement hole, and the closed state of the door member 15 is maintained (a state where the door member 15 is locked). When the operating portion 16 is pressed down in this state, a state where the pin 17 is released from the engagement hole (a state where the door member 15 is unlocked) is established, and the door member 15 can be opened.

The means for locking the door member 15 is not limited to the above-described embodiment, and any means may be used. For example, instead of the pin 17, a locking claw or a screw may be used.

An engaging portion 15c protrudes obliquely upward and rearward from the rear end of the door member 15 (refer to FIGS. 1, 2, and 6B). The engaging portion 15c is a part that engages with the magazine cap portion 22 in order to keep the magazine cap portion 22 in a closed state. When the door member 15 is closed after the magazine cap portion 22 is closed, the engaging portion 15c of the door member 15 engages with the magazine cap portion 22, and the magazine cap portion 22 can be maintained in a closed state. In other words, when the door member 15 is locked, the magazine cap portion 22 is also locked in a closed state at the same time.

As shown in FIG. 1, when the door member 15 is closed, the door member 15 is disposed to face the guide plate portion 12b (nose-side guide surface 12c). As a result, the feed path 35 is formed between a door-side guide surface 15b formed on the inside of the door member 15 and the nose-side guide surface 12c. In other words, at least a part of the feed path 35 is formed by the nose-side guide surface 12c of the nose portion 12 and the door-side guide surface 15b of the door member 15.

In the present embodiment, the front portion of the feed path 35, which is continuous with the injection passage 12a, is formed by the nose-side guide surface 12c of the nose portion 12 and the door-side guide surface 15b of the door member 15, and the rear portion of the feed path 35, which is continuous with the rear of the feed path 35 at the front, is formed by the nose-side guide surface 12c of the nose portion 12 and the magazine cap-side guide surface 26c (described later) of the magazine cap portion 22.

The feed mechanism 30 for feeding the connected nails forward is provided on the side (right side) of this feed path 35. The feed mechanism 30 operates in conjunction with the driving operation of the nail 50 to automatically execute an operation of feeding the nails 50 forward one by one. The feed mechanism 30 feeds the nails 50 set in the feed path 35 forward, and accordingly, the leading nail 50 of the connected nails is fed to the injection passage 12a. The feed mechanism 30 according to the present embodiment includes the piston-cylinder mechanism 31, the feed claw 32, and the check claw 33.

The piston-cylinder mechanism 31 is driven by compressed air or the like, and is activated in conjunction with the driving operation of the nail 50. The piston-cylinder mechanism 31 is configured such that a piston rod 31a makes one reciprocation each time the driving operation of the nail 50 is executed. The nail feeding operation is executed by one reciprocation of the piston rod 31a.

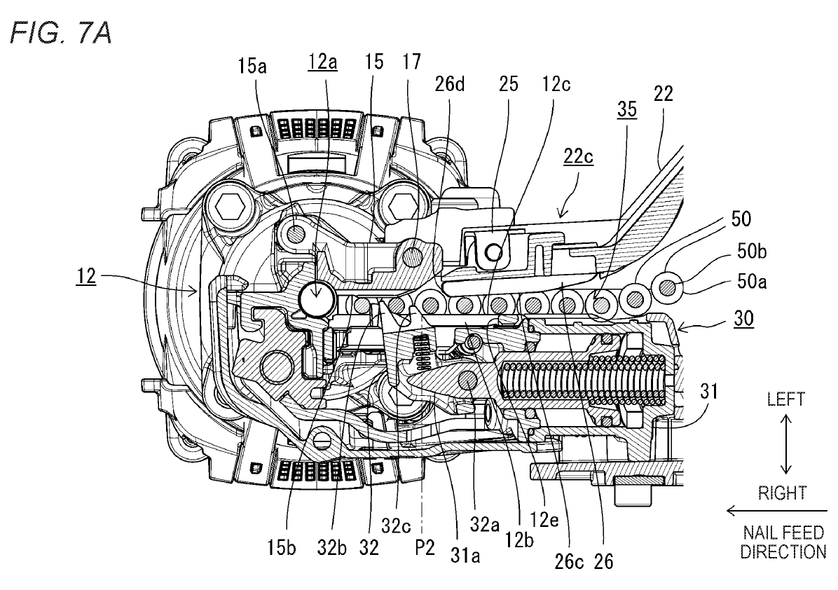

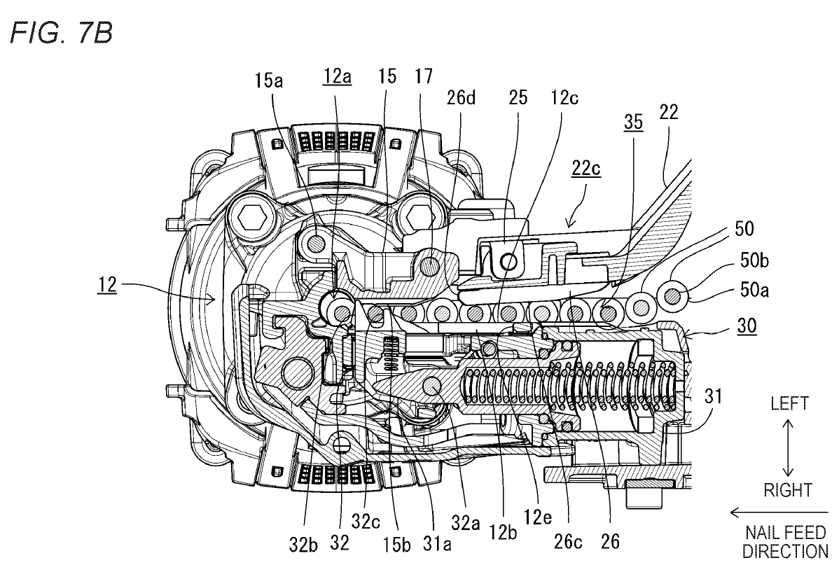

The feed claw 32 is a member for feeding the connected nails arranged on the feed path 35 forward one by one. The feed claw 32 is capable of reciprocating back and forth along the feed path 35. As illustrated in FIGS. 7A, 7B, the feed claw 32 is fixed to the piston rod 31a via a rotation shaft 32a, and reciprocates back and forth in conjunction with the piston rod 31a. The tip end of the feed claw 32 is bifurcated into a front claw portion 32b on the front side and a rear claw portion 32c on the rear side. The interval between the front claw portion 32b and the rear claw portion 32c is a width that allows the body portion 50b of the nail 50 to enter.

This feed claw 32 is configured to engage with one nail 50 of the connected nails in the feed path 35 during the retraction, and to feed one nail 50 forward during the advancement. Specifically, when the nail 50 is driven from the state of FIG. 7B, the piston-cylinder mechanism 31 is activated, and the feed claw 32 retracts. At this time, since the feed claw 32 is rotatably attached to the tip end of the piston rod 31a, the feed claw 32 is pushed out by the nail 50 and rotates in the direction of retracting from the feed path 35. That is, the feed claw 32 swings to disengage from the nail 50. Then, as shown in FIG. 7A, when the feed claw 32 retracts to the position of the nail 50 located one behind, the front claw portion 32b and the rear claw portion 32c protrude again into the feed path 35 by the force of a spring. As a result, the feed claw 32 engages with the nail 50 located one behind. Then, as illustrated in FIG. 7B, by the feed claw 32 advancing, the nail 50 advances forward by one nail. This retraction and advancement cycle of operation is executed each time one driving operation of the nail 50 is executed.

The check claw 33 is a member for preventing the connected nails from moving backward to the rear. As illustrated in FIG. 6A, the check claw 33 is provided to be rotatable relative to the nose portion 12 via a rotation shaft 33a. The check claw 33 is configured such that a locking portion 33b provided at the tip end can protrude into the feed path 35. The check claw 33 is biased by biasing means such as a spring in a direction in which the locking portion 33b protrudes into the feed path 35. Therefore, even when the nail 50 attempts to move rearward, the front surface of the locking portion 33b catches, and the movement is suppressed. On the other hand, when the nail 50 moves forward, the rear inclined surface of the locking portion 33b is pushed out by the nail 50 and rotates in the direction retracting from the feed path 35, and thus the forward movement of the nail 50 is not impeded.

Next, the guide forming portion 22c of the magazine cap portion 22 will be described.

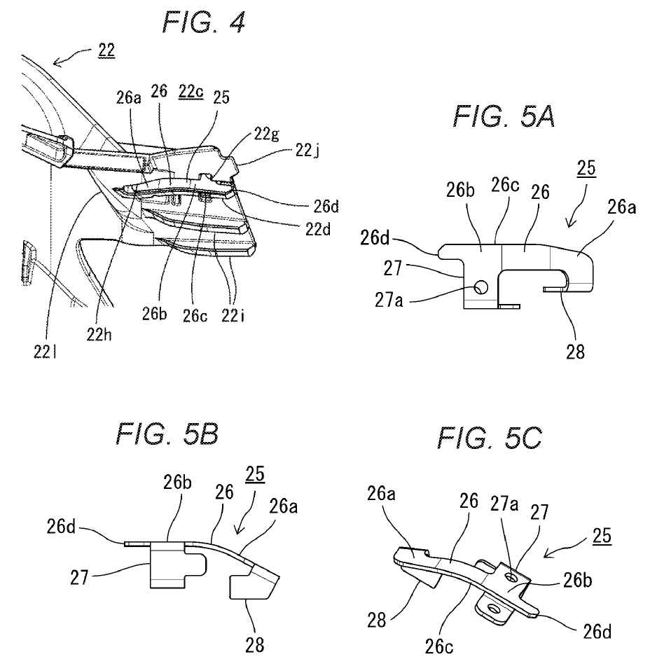

As illustrated in FIG. 4, the guide forming portion 22c is a plate-shaped part that protrudes forward from the half-cylinder portion 22a of the magazine cap portion 22. The guide forming portion 22c is disposed to face the guide plate portion 12b (nose-side guide surface 12c) when the magazine cap portion 22 is closed. As a result, the feed path 35 is formed between the magazine cap-side guide surface 26c formed inside the guide forming portion 22c and the nose-side guide surface 12c. In other words, at least a part of the feed path 35 is formed by the nose-side guide surface 12c of the nose portion 12 and the magazine cap-side guide surface 26c of the magazine cap portion 22.

A head support portion 22d and a body support portion 22i are formed inside the guide forming portion 22c. The head support portion 22d and the body support portion 22i are protrusions that protrude from the inner surface of the guide forming portion 22c and extend in the front-rear direction. The head support portion 22d and the body support portion 22i are parts that hold the nail 50. These parts suppress the tilting of the nail 50 to the left. The head support portion 22d mainly supports the head portion 50a of the nail 50. The body support portion 22i mainly supports the body portion 50b of the nail 50. It should be noted that the head support portion 22d and the body support portion 22i need not to be clearly distinguishable from each other, and the head support portion 22d and the body support portion 22i may be formed integrally with each other. For example, the functions of the head support portion 22d and the body support portion 22i may be simultaneously realized by the protrusion formed with a constant width in the up-down direction.

The head support portion 22d supports the head portion 50a of the nail 50 from below. The head portion 50a of the nail 50 can move along the upper surface of the head support portion 22d. The head support portion 22d according to the present embodiment has the metal member 25 attached to the part that comes into contact with the nail 50.

The metal member 25 is a small member as illustrated in FIGS. 5A, 5B, 5C. The metal member 25 is formed by bending a plate made of metal. The metal member 25 integrally includes a guide portion 26, a first holding portion 27, and a second holding portion 28.

The guide portion 26 is a part that covers the upper surface of the head support portion 22d. The guide portion 26 is formed in substantially the same shape as the head support portion 22d. The left and right width of the guide portion 26 covering the upper surface of the head support portion 22d (the width of the part exposed inside the magazine cap portion 22 in a state where the metal member 25 is assembled to the magazine cap portion 22 as illustrated in FIG. 4) is set to be approximately the same as the left and right width of the head support portion 22d. Desirably, the left-right width of the guide portion 26 is the same as the left-right width of the head support portion 22d or slightly larger than the left-right width of the head support portion 22d. By forming the guide portion 26 in this manner, the side surface of the tip end of the guide portion 26 can support the posture of the nail 50, that is, the side surface of the tip end of the guide portion 26 forms the magazine cap-side guide surface 26c, which will be described later.

The guide portion 26 includes an inclined portion 26a and a straight portion 26b in accordance with the shape of the head support portion 22d. The inclined portion 26a is formed to incline upward from the rear end to the front. The straight portion 26b continues from the front end of the inclined portion 26a and is formed substantially parallel to the front-rear direction. The connected nails passing through the feed path 35 is guided upward along the inclined portion 26a and then guided straight forward along the straight portion 26b. The guide path of this guide portion 26 corresponds to the guide groove 12d formed in the nose portion 12.

The protruding surfaces of the inclined portion 26a and the straight portion 26b (the surfaces facing the nose-side guide surface 12c when the magazine cap portion 22 is closed) form the magazine cap-side guide surface 26c that forms the feed path 35. That is, as illustrated in FIG. 6A, the nail 50 is configured to pass between the nose-side guide surface 12c and the magazine cap-side guide surface 26c. At this time, the minimum width between the nose-side guide surface 12c and the magazine cap-side guide surface 26c is set to be equal to or larger than the diameter of the body portion 50b of the nail 50 to be guided and smaller than the diameter of the head portion 50a of the nail 50. In other words, the maximum width of the feed path 35 formed by the nose-side guide surface 12c and the magazine cap-side guide surface 26c is a width that allows the body portion 50b of the nail 50 to pass through but does not allow the head portion 50a of the nail 50 to pass through. Therefore, the head portion 50a of the nail 50 placed on the upper surface of the guide portion 26 will not fall downward.

The first holding portion 27 and the second holding portion 28 of the metal member 25 are parts used to attach the metal member 25 to the magazine cap portion 22. The metal member 25 is fixed immovably to the magazine cap portion 22 by the first holding portion 27 and the second holding portion 28.

The first holding portion 27 is formed to protrude substantially in a U-shape to the side from the vicinity of the front end of the guide portion 26. The first holding portion 27 penetrates a first slit 22g (refer to FIG. 4) formed in the guide forming portion 22c of the magazine cap portion 22 and extends from the inside to the outside of the guide forming portion 22c. The first holding portion 27 engages with an outer rib 22f formed on the surface of the guide forming portion 22c to embrace the outer rib 22f (refer to FIG. 3). The first holding portion 27 is fixed to the magazine cap portion 22 by an attachment pin 29 attached from the outside of the magazine cap portion 22. The first holding portion 27 is formed with an attachment hole 27a through which the attachment pin 29 penetrates.

The second holding portion 28 is formed to protrude substantially in an L-shape to the side from the vicinity of the rear end of the guide portion 26. The second holding portion 28 penetrates a second slit 22h (refer to FIG. 4) formed in the guide forming portion 22c of the magazine cap portion 22 and extends from the inside to the outside of the guide forming portion 22c. The tip end of the second holding portion 28 is inserted into a holding hole 22k (refer to FIG. 1) provided on the outside of the magazine cap portion 22 and fixed therein.

As described above, in the present embodiment, at least a part of the feed path 35, which is conventionally formed by the nose portion 12 and the door member 15, can be formed by the nose portion 12 and the magazine cap portion 22. Therefore, even when the door member 15 made of metal is used, the door member 15 can be made smaller, and weight reduction can be achieved. That is, in the related art, since the feed path is formed by the nose portion and the door member, the door member extends toward the magazine. On the other hand, in the present disclosure, since at least the part of the feed path 35 can be formed by the magazine cap portion 22 instead of the door member, it is not necessary to extend the door member toward the magazine in order to form the feed path. Therefore, the door member 15 made of metal can be made smaller than the related art, and the weight reduction can be achieved.

It should be noted that the “feed path 35” in the present invention substantially supports the posture of the nail 50. In other words, the “nose-side guide surface 12c” and the “magazine cap-side guide surface 26c” of the present invention exert the effect of suppressing the tilting of the nail 50 by coming into contact with the body portion 50b of the nail 50. In other words, a part that simply covers the nail 50 (for example, a tapered portion 22l provided to connect the half-cylinder portion 22a and the guide forming portion 22c as illustrated in FIGS. 4 and 6A) does not form the “nose-side guide surface 12c” or the “magazine cap-side guide surface 26c”.

In the present embodiment, the nose portion 12 and the door member 15 or the magazine cap portion 22 form the feed path 35. The door member 15 and the magazine cap portion 22 are arranged side by side in the front-rear direction and form a guide surface that guides the left side of the nail 50. Here, there is a gap between the door member 15 and the magazine cap portion 22 (metal member 25) as illustrated in FIG. 6A and the like. Therefore, the guide surface is not completely continuous. For example, in the state illustrated in FIG. 6A, a cut exists on the left side of the fourth nail 50 from the leading, and the left side of this fourth nail 50 is not supported. However, since each nail 50 is connected to the nails 50 before and after the nail 50, the nail 50 will not fall from the feed path 35.

In order to substantially support the posture of the nail 50, it is desirable that the minimum width between the nose-side guide surface 12c and the magazine cap-side guide surface 26c be set to be equal to or smaller than the diameter of the head portion 50a of the nail 50 to be guided. By setting the minimum width in this manner, resistance when feeding the nail 50 into the injection passage 12a, which is configured with an inner diameter that allows the head portion 50a of the nail 50 to enter, is suppressed, and the feeding operation is stabilized.

It is also desirable that the magazine cap-side guide surface 26c extend further forward than the rotation shaft 33a of the check claw 33 when viewed in the nail feed direction. Specifically, as illustrated in FIG. 6A, it is desirable that a front end 26d of the magazine cap-side guide surface 26c be located forward of the rotation shaft 33a of the check claw 33. By extending the magazine cap-side guide surface 26c in this manner, the check claw 33 can be activated while being guided by the lightweight magazine cap-side guide surface 26c. Furthermore, the area of the door member 15 can be reduced, and weight reduction can be achieved.

In addition, as illustrated in FIG. 6A, it is desirable that the front end 26d of the magazine cap-side guide surface 26c, as viewed in the nail feed direction, be located rearward of the position where the check claw 33 protrudes to the feed path 35. That is, it is desirable to provide the magazine cap-side guide surface 26c within a range not exceeding a rearmost position P1 at which the check claw 33 protrudes to the feed path 35. With this configuration, the load when the check claw 33 protrudes to the feed path 35 is less likely to be received by the magazine cap-side guide surface 26c (in other words, the load is received by the door member 15 and the like), thereby preventing wear and damage to the magazine cap portion 22.

In addition, as illustrated in FIG. 7A, it is desirable that the front end 26d of the magazine cap-side guide surface 26c, as viewed in the nail feed direction, be located rearward of the position where the feed claw 32 protrudes to the feed path 35. That is, it is desirable to provide the magazine cap-side guide surface 26c within a range not exceeding a rearmost position P2 at which the retracted feed claw 32 protrudes to the feed path 35. With this configuration, the load when the feed claw 32 protrudes to the feed path 35 is less likely to be received by the magazine cap-side guide surface 26c (in other words, the load is received by the door member 15 and the like), thereby preventing wear and damage to the magazine cap portion 22.

Moreover, it is desirable that the magazine cap-side guide surface 26c be configured by the metal member 25 attached to the magazine cap portion 22, as in the present embodiment. This allows the part that comes into contact with the nail 50 to be made of metal, improving wear resistance. Furthermore, only the part necessary for guiding the nails 50 is made of metal, the main body of the magazine cap portion 22 can be made of a lightweight material, and thus the increase in weight can be minimized.

As illustrated in FIG. 4, an engaged portion 22j is formed at the front end of the above-described magazine cap portion 22 (the front end of the guide forming portion 22c). The engaged portion 22j according to the present embodiment is a protrusion that protrudes forward. As illustrated in FIG. 6B, this engaged portion 22j is formed at a position that overlaps with the engaging portion 15c of the door member 15 when the magazine cap portion 22 and the door member 15 are closed.

When the door member 15 is closed after the magazine cap portion 22 is closed, the engaged portion 22j is held by the engaging portion 15c. When the door member 15 is locked in this state, the magazine cap portion 22 is also locked. On the other hand, when the door member 15 is unlocked and the door member 15 is opened, the magazine cap portion 22 can also be opened. When the door member 15 is opened, the magazine cap portion 22 may be biased in the opening direction by biasing means such as a spring such that the magazine cap portion 22 opens automatically.

As illustrated in FIG. 1, the engaging portion 15c of the door member 15 engages with the magazine cap portion 22 above the head portion 50a of the nail 50 disposed in the feed path 35. By adopting such an arrangement, when the magazine cap portion 22 is viewed in the up-down direction, the feed path 35 for the nails 50 is formed between the magazine rotation shaft 22b and the engaging portion 15c. Therefore, the magazine cap portion 22 is fixed above and below the nail 50 passing through the feed path 35, and the magazine cap portion 22 can stably support the nail 50.

In the above embodiment, an example in which the metal member 25 that forms the magazine cap-side guide surface 26c is fixed immovably to the magazine cap portion 22 is described. However, the embodiment of the present invention is not limited to this, and the member that forms the magazine cap-side guide surface 26c may be movable.

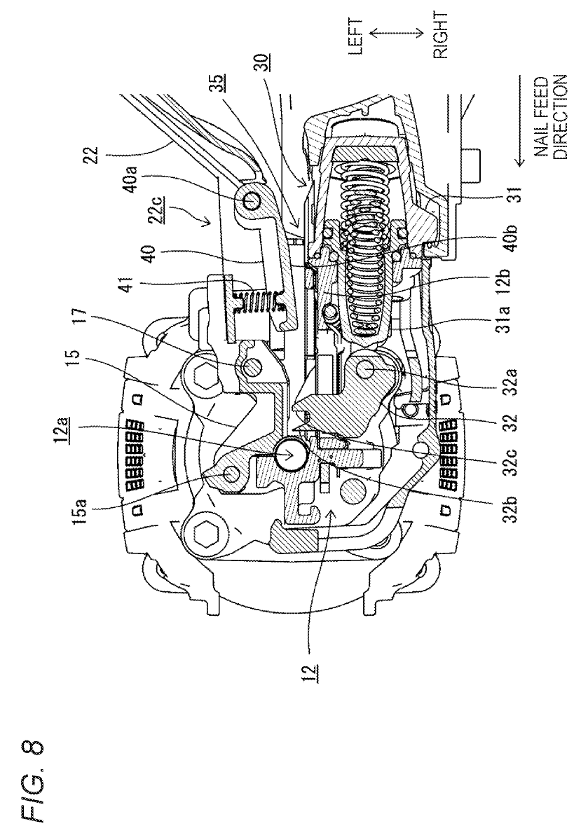

For example, as illustrated in FIG. 8, the magazine cap portion 22 may include a movable member 40 that is movable to change the width of the feed path 35. The movable member 40 according to this modified example is capable of swinging about a swing shaft 40a provided on the magazine cap portion 22. The magazine cap portion 22 has a biasing member 41 that biases the movable member 40 in a direction that narrows the width of the feed path 35. The movable member 40 is biased by the biasing member 41 in a direction of protruding into the feed path 35, and the surface of the movable member 40 is advanceable and retractable into the feed path 35. The surface of this movable member 40 forms a guide portion (magazine cap-side guide surface 40b) that is advanceable and retractable in the width direction of the feed path 35, and thus the minimum width of the feed path 35 changes when the movable member 40 swings. According to this modified example, the swinging of the movable member 40 can dissipate impacts and suppress wear and damage to components. Furthermore, even when guiding a nail 50 with a small diameter, the guide width becomes narrower due to being biased by the biasing member 41, and thus the effect of guiding (suppression of tilting) is improved.

As described above, according to the present disclosure, at least a part of the feed path, which has conventionally been formed by the nose portion and the door member, can be formed by the nose portion and the magazine cap portion. Therefore, even when a door member made of metal is used, the door member can be made smaller, and weight reduction can be achieved.

It should be noted that the “feed path” in the present invention substantially supports the posture of the nail. In other words, the “nose-side guide surface” and the “magazine cap-side guide surface" in the present invention function to suppress tilting of the nail by coming into contact with the nail. That is, the parts that merely cover the nail do not constitute the “nose-side guide surface” or the “magazine cap-side guide surface”.

What is claimed is:

1. A nail driving machine comprising:
a magazine configured to accommodate connected nails in which a plurality of nails are connected; and
a nose portion having an injection passage of the nails, wherein
a feed path configured to guide the connected nails from the magazine to the injection passage is provided,
the magazine includes a magazine main body capable of accommodating the connected nails, and a magazine cap portion attached to the magazine main body to be openable and closable, and
at least a part of the feed path is formed by a nose-side guide surface of the nose portion and a magazine cap-side guide surface of the magazine cap portion.

2. The nail driving machine according to claim 1, wherein
a maximum width of the feed path formed by the nose-side guide surface and the magazine cap-side guide surface is set to be smaller than a diameter of a head portion of the nail to be guided.

3. The nail driving machine according to claim 1, further comprising:
a feed mechanism configured to feed the connected nails from the feed path to the injection passage, wherein
the feed mechanism includes a feed claw configured to feed the connected nails to the injection passage, and a check claw provided to be rotatable to prevent the connected nails from moving backward toward a direction opposite to a feed direction toward the injection passage, and
the magazine cap-side guide surface extends forward, in a nail feed direction, beyond a rotation shaft of the check claw.

4. The nail driving machine according to claim 2, wherein
a check claw is provided to be rotatable in the feed path to prevent the connected nails from moving backward to a rear, and
a front end of the magazine cap-side guide surface, as viewed in a nail feed direction, is configured to be rearward of a position where the check claw is to protrude to the feed path.

5. The nail driving machine according to claim 2, further comprising:
a feed claw configured to feed the connected nails arranged in the feed path forward one by one, wherein
a front end of the magazine cap-side guide surface, as viewed in a nail feed direction, is located rearward of a position where the feed claw is to protrude to the feed path.

6. The nail driving machine according to claim 1, wherein
the magazine cap-side guide surface is configured by a metal member attached to the magazine cap portion.

7. The nail driving machine according to claim 2, further comprising:
a door member attached to be openable and closable to the nose portion in order to open the feed path, wherein
at least a part of the feed path is formed by the nose-side guide surface provided on the nose portion and a door-side guide surface provided on the door member.

8. The nail driving machine according to claim 7, wherein
the door member is made of metal.

9. The nail driving machine according to claim 7, wherein
the door member has an engaging portion configured to engage with the magazine cap portion in order to keep the magazine cap portion in a closed state, and
the engaging portion is configured to engage with the magazine cap portion above the head portion of the nail disposed in the feed path.

10. The nail driving machine according to claim 1, wherein
the magazine cap portion includes a movable member that is movable to change a width of the feed path.

11. The nail driving machine according to claim 10, wherein
the movable member has a guide portion that is advanceable and retractable in a width direction of the feed path.

12. The nail driving machine according to claim 11, wherein
the guide portion forms the magazine cap-side guide surface.

13. The nail driving machine according to claim 10, wherein
the magazine cap portion has a biasing member configured to bias the movable member in a direction to narrow the width of the feed path.
